(19) United States
(12) Patent Application Publication
(10) Pub. No.: US 2025/0333024 A1
(43) Pub. Date: Oct. 30, 2025

(54) WIPER SYSTEM CONNECTION MODULE

(71) Applicant: VALEO SYSTÈMES D'ESSUYAGE, LE MESNIL SAINT DENIS (FR)

(72) Inventors: Stephane HOUSSAT, La Verriere (FR); Vincent GAUCHER, La Verrière (FR); Guillaume MOULEYRE, La Verrière (FR); Olivier JOMARD, La Verrière (FR)

(73) Assignee: VALEO SYSTEMES D'ESSUYAGE, La Verriere (FR)

(21) Appl. No.: 18/866,594

(22) PCT Filed: May 17, 2023
(86) PCT No.: PCT/EP2023/063400

§ 371 Date: Nov. 18, 2024

(30) Foreign Application Priority Data
May 19, 2022 (FR) FR2204811

(51) Int. Cl. B60S 1/40

(52) U.S. Cl. CPC B60S 1/4003; B60S 1/4009; B60S 1/4083

(57) ABSTRACT

The present invention is a connection module for connecting a connection device of a wiper extending in a longitudinal direction to an arm of a wiper system. The connection module being, for the one part, able to be mounted on a connector of the connection device configured to bear the wiper and, for the other part, connected to the arm, the connection module including a cover that is pivotable about a pivot axis and comprises blocking means for blocking at least one type of arm. The cover includes an elastically deformable tongue on which the blocking means are disposed.

### TECHNICAL FIELD

The field of the present invention is that of wiper systems intended for automotive vehicles. More particularly, the field of the present invention is that of connection devices disposed between a wiper arm and a wiper of such wiper systems.

### BACKGROUND OF THE INVENTION

Automotive vehicles are commonly fitted with wiper systems intended to clean their glazed surfaces, and notably their windshield. Such wiper systems comprise at least one wiper arm and a wiper driven by the wiper arm. The wiper arm is connected to an electric motor of the vehicle and the wiper comprises at least one wiper blade intended to come into contact with the glazed surface to be wiped.

In order to be able to drive the wiper, a connection device is arranged between this wiper and the wiper arm. More particularly, the connection device comprises an adapter arranged between the wiper arm and a connector connected to the wiper. The adapter is then secured to the wiper arm and more particularly to a free end of the wiper arm, such a cooperation being detachable such that it allows the wiper to be changed when it is worn.

However, different types of wiper arms are currently fitted to automotive vehicles, forcing automotive equipment manufacturers to design different adapters specific to each type of arm, one adapter specifically linking one type of wiper arm to one connector. This feature firstly pushes automotive equipment manufacturers to develop many different adapters, including at least one for each type of wiper arm on the market, and secondly requires users needing to change their wiper to adapt and pay extra attention in order to select the correct adapter according to the type of wiper arm on which the wiper must be mounted.

### SUMMARY OF THE INVENTION

The present invention falls within this context by proposing a universal connection device between a wiper and an arm, that is to say a connection device for connecting a wiper to a large number of different types of arms currently on the market.

In this context, the main subject of the present invention is a connection module for connecting a connection device of a wiper extending in a longitudinal direction to an arm of a wiper system, the connection module being, for the one part, able to be mounted on a connector of the connection device configured to bear the wiper and, for the other part, able to be connected to the arm, the connection module comprising a cover that is pivotable about a pivot axis and comprises blocking means for blocking at least one type of arm, characterized in that the cover has an elastically deformable tongue on which said blocking means are disposed.

The wiper and the wiper arm form part of a vehicle wiper system intended to at least partially clean a glazed surface of said vehicle. The wiper system more particularly comprises the wiper arm, an electric motor configured to drive the rotation of the arm and to enable a back and forth movement of the wiper along the glazed surface and the cleaning of this glazed surface by a blade borne by the wiper, the wiper being made to move as one with the arm via the connection device.

As mentioned, the connection device comprises a connection module mounted on a connector secured to the wiper, the connection module notably being able to be pivotably mounted in order to allow, in a known manner, the assembly formed by the connector and the wiper to pivot with respect to the wiper arm so as to adapt the position of the wiper against the glazed surface to be wiped during the back and forth movement of the wiper.

The cover is pivotably mounted on the structure of the connection module, notably in order to participate, when the cover is folded down on the connection module, in locking wiper arms against the connection module and/or in blocking movable components of the connection module against one another. The cover is notably in this position when an arm is secured to the connection module. It will thus be understood that the cooperation between the connection module, and more particularly a base of the connection module, and the cover participates in securing the connection module to the arm when the cover is in the covering position. Conversely, when the cover is in the release position, it no longer cooperates with the base or other components of the connection module, thus allowing a possible uncoupling between the arm and the connection module, in order to be able to remove the connection module from the arm, for example.

According to another optional feature of the invention, the elastically deformable tongue is movable about a bending direction parallel to the pivot axis.

According to another optional feature of the invention, the elastically deformable tongue is formed in an upper wall configured to at least partially cover the arm in a covering position of the cover.

According to another optional feature of the invention, the elastic deformable tongue has a thickness greater than the average thickness of the upper wall. In this case, the thickness is measured in a direction perpendicular to the main plane of extension of the upper wall and/or of the elastically deformable tongue.

According to another optional feature of the invention, the elastically deformable tongue is delimited by two longitudinal grooves opening out at a free end edge of the upper wall. The two longitudinal grooves extend along a longitudinal dimension from the free end edge such that the bottom walls of these grooves are aligned in a direction parallel to the pivoting direction so that the elastically deformable tongue is movable about a bending direction parallel to the pivoting direction. Preferably, the two grooves extend parallel to one another.

According to another optional feature of the invention, one of the blocking means comprises a shoulder formed in the free end edge of the upper wall, the shoulder being intended to cooperate with a type of wiper arm.

According to another optional feature of the invention, a gripping tab extends in the continuation of the free end edge of the elastically deformable tongue. The gripping tab can notably allow the cover to be manipulated and facilitate its pivoting between a covering position and a release position, and this gripping tab may also form one of the blocking means mentioned above.

According to another optional feature of the invention, one of the blocking means comprises at least one wedging means extending in a plane perpendicular to the pivoting direction at least partially from the elastically deformable tongue, the wedging means being intended to longitudinally wedge the position of a type of arm.

According to another optional feature of the invention, the cover is pivotably mounted on a base of the connection module and the cover comprises at least one locking means which extends from the elastically deformable tongue and which is configured to cooperate with a complementary locking member formed on the base.

The base may notably comprise a guide block, one of the walls of which comprises at least one cutout intended to cooperate with a tooth forming the locking means of the cover in order to block the cover on the guide block, and therefore on the base of the connection module, in the covering position.

According to one feature of the invention, the at least one locking means and the at least one wedging means, which are at least partially borne by the elastically deformable tongue, are offset with respect to one another along the pivot axis.

According to another optional feature of the invention, the cover is pivotably mounted on a base of the connection module and the cover comprises at least one locking means which extends from at least one of the lateral walls of the cover and which is configured to cooperate with a complementary locking member formed on the base and more particularly on the guide block.

In this variant, the locking means of the cover may take the form of a locking stud and the complementary locking member of the base may take the form of a through-opening.

According to another optional feature of the invention, the cover comprises at least a front wall, an upper wall and two lateral walls, the front wall and the upper wall extending transversely between the lateral walls, the lateral walls at least partially bearing a pivot element at an end opposite the upper wall. This pivot element participates in guiding the rotational movement of the cover about the pivot axis between the covering position and the release position. To do so, the pivot element cooperates with a pivot member of the base.

According to another optional feature of the invention, the front wall is formed in the continuation of the upper wall and has a stop edge, on the opposite side from the upper wall, which is delimited transversely by the lateral walls, the stop edge being configured to cooperate with the base in order to define the release position of the cover. More precisely, the stop edge is in contact with the base when the cover is in the release position.

According to another optional feature of the invention, each of the lateral walls comprises an extension portion extending beyond the stop edge of the front wall, the pivot element being at least partially disposed on one and/or the other of the extension portions of the lateral walls.

According to another optional feature of the invention, each of the extension portions bears a pivot element, the pivot elements aligning with one other in a direction parallel to the pivot axis.

According to another optional feature of the invention, the extension portions are offset laterally with respect to the main planes of extension of the lateral walls. In other words, a main plane of extension of each of the extension portions is separate from a plane in which one or the other of the lateral walls extends.

According to another optional feature of the invention, the stop edge of the front wall extends between the two extension portions of the lateral walls.

According to another optional feature of the invention, the pivot element comprises at least one orifice passing through one of the lateral walls, the base comprising a pivot device having at least one shaft protruding transversely from the base to the first longitudinal end and having one end at least partially housed in the orifice of the pivot element.

According to another optional feature of the invention, the pivot element comprises at least one boss protruding from an inner face of one of the lateral walls, the boss being intended to closely guide the cover against a wall of the base when the cover is pivoted about the pivot axis.

According to another optional feature of the invention, the cover comprises at least one rib which extends along an inner face of a lateral wall and is configured to bear against a wall of the guide block of the base.

According to another optional feature of the invention, the rib extends from the front wall toward a free end of the lateral wall parallel to the longitudinal direction.

According to another optional feature of the invention, the cover comprises at least one first rib disposed on one of the lateral walls and at least one second rib disposed on the other lateral wall, the ribs protruding toward the inside of the cover.

According to another optional feature of the invention, the first rib extends parallel to the second rib.

According to one feature of the invention, the connection module comprises at least one base pivotably mounted about an axis of pivoting on the connector and a rotary platform rotationally mounted about an axis of rotation on the base by being movable between a working position and a mounting position, the axis of pivoting and the axis of rotation extending parallel to and separately from one another, and the cover is pivotably mounted on the base about a pivot axis, said cover being movable between a covering position and a release position, the cover and the rotary platform being disposed on the base such that the cover in the covering position locks a free end of the rotary platform when said rotary platform is in the working position.

According to an optional feature of the invention, the axis of rotation and the pivot axis are formed at opposite longitudinal ends of the base.

The longitudinal offset between the two parts of the connection module makes it possible to generate an angular movement of the platform with respect to the base which is sufficient so that, in a position in which the platform is released from the base, the platform can cooperate with different types of wiper arm independently of the base, the platform and the base being moreover configured to lock the position of these different types of wiper arm once the position of the platform is fixed with respect to that of the base.

A subject of the present invention is also a connection device comprising a connector bearing a wiper and a connection module characterized according to any one of the preceding features and able to be mounted on the connector.

A subject of the present invention is additionally a wiper comprising a wiper blade and a connection device according to any one of the preceding features.

A subject of the present invention is lastly a wiper system comprising at least one wiper arm and a wiper according to the preceding feature, the wiper being disposed at one end of the wiper arm, the wiper arm being secured to the wiper through cooperation with the connection device.

### BRIEF DESCRIPTION OF DRAWINGS

Other features, details and advantages of the invention will become more clearly apparent on reading the description below and on studying several exemplary embodiments given by way of non-limiting indication with reference to the appended schematic drawings, in which:

FIG. 1 is a perspective representation of a wiper on which a connection device according to the invention is mounted;

FIG. 2 is an exploded view of the wiper and the connection device shown in FIG. 1;

FIG. 3 is a perspective view of a connector, a connection module comprising a base and a rotary platform, and a cover, forming the connection device shown in FIG. 1;

FIG. 4 is a perspective representation from above of the base of the connection module shown in FIG. 3;

FIG. 5 is a perspective representation from below of the base of the connection module shown in FIG. 3;

FIG. 6 is a perspective representation from above of the rotary platform of the connection module shown in FIG. 3;

FIG. 7 is a perspective representation from below of the rotary platform of the connection module shown in FIG. 3;

FIG. 8 is a perspective representation of the cover shown in FIG. 3;

FIG. 9 is a longitudinal section of the connection device shown in FIG. 3 and in which the cover cooperates with the rotary platform;

FIG. 10 is a longitudinal section of the connection device shown in FIG. 1 and mounted on a first type of wiper arm;

FIG. 11 is a perspective representation of the connection device shown in FIG. 1 and mounted on a second type of wiper arm; and

FIG. 12 is a longitudinal section of the connection device shown in FIG. 3 and mounted on a third type of wiper arm.

### DETAILED DESCRIPTION OF THE INVENTION

The features, variants and different embodiments of the invention may be combined with one another, in various combinations, as long as they are not mutually incompatible or mutually exclusive. It will be possible, in particular, to imagine variants of the invention that comprise only a selection of the features described below, in isolation from the other features described, if this selection of features is sufficient to confer a technical advantage and/or to distinguish the invention from the prior art.

In the figures, elements that are common to multiple figures retain the same reference sign.

In the detailed description which follows, the terms “longitudinal”, “transverse” and “vertical” refer to the orientation of a wiper system according to the invention. A longitudinal direction corresponds to a main direction of elongation of a wiper of the wiper system, this longitudinal direction being parallel to a longitudinal axis L of a frame of reference L, V, T illustrated in the figures. A vertical direction corresponds to a direction of stacking of a connector, a base and a rotary platform of a connection device of the wiper system, this vertical direction being parallel to a vertical axis V of the frame of reference L, V, T and this vertical axis V being perpendicular to the longitudinal axis L. Lastly, a transverse direction corresponds to a direction parallel to a transverse axis T of the frame of reference L, V, T, this transverse axis T being perpendicular to the longitudinal axis L and the vertical axis V.

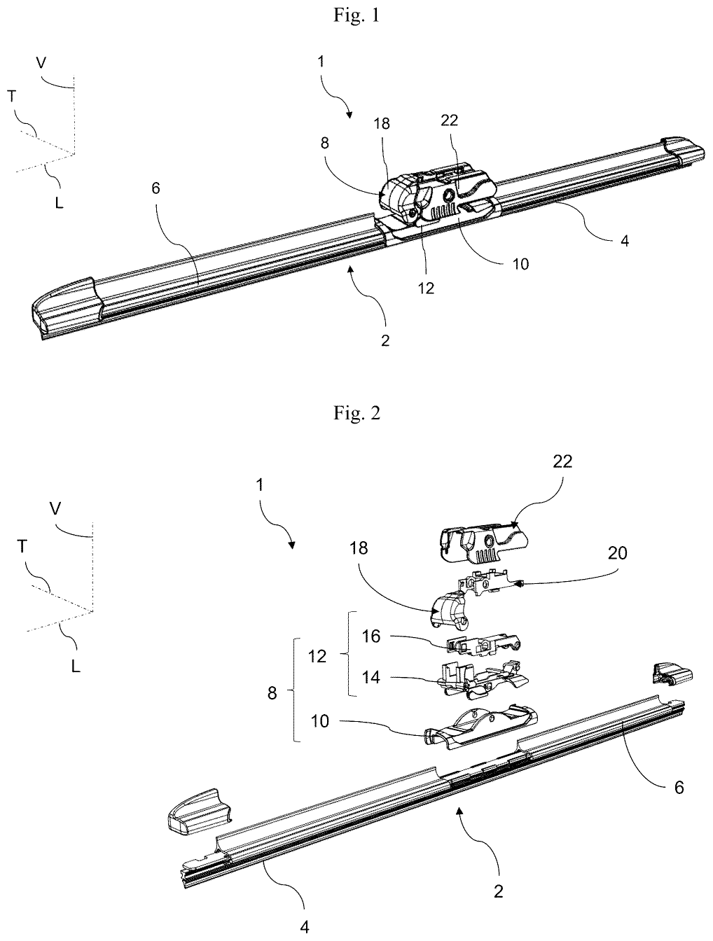

FIG. 1 illustrates a wiper system 1 configured for cleaning a glazed surface of a vehicle, for example a windshield, so as to improve a driver's view of the road in front of the vehicle. The wiper system 1 comprises at least one wiper arm, not shown in FIG. 1, bearing at one end a wiper 2 which extends mainly in the longitudinal direction L.

The wiper 2 comprises at least one wiper blade 4, intended to be in contact with the glazed surface to be cleaned, and a support 6 for said wiper blade 4.

The wiper 2 is also secured to the wiper arm by a connection device 8. The connection device 8 comprises a connector 10 and a connection module 12 according to the invention pivotably mounted on the connector 10, the latter being secured to the wiper 2 while the connection module 12 is configured to be secured to the wiper arm of the wiper system 1.

The pivotable mounting of the connection module 12 on the connector 10 thus makes it possible for the wiper 2 to be pivoted at one of the ends of the wiper arm, and to thus ensure that the wiper blade 4 is pressed against the glazed surface to be wiped.

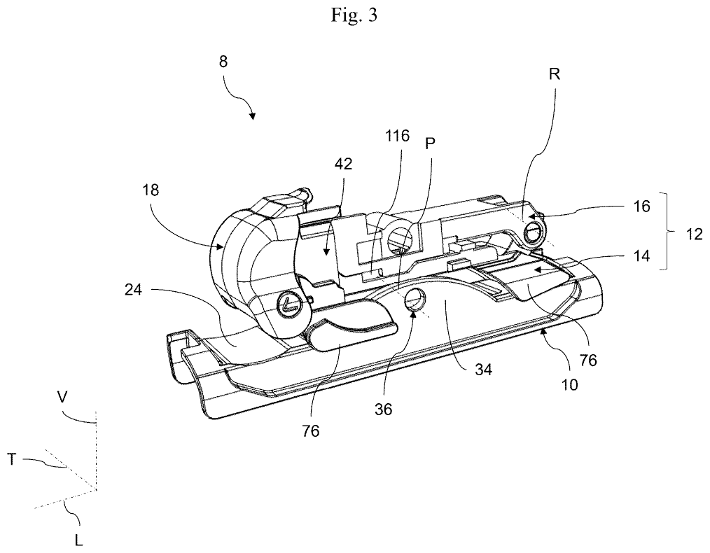

More particularly and as can be seen in FIG. 2 and FIG. 3, the connection module 12 comprises a base 14, pivotably mounted about an axis of pivoting P on the connector 10, and a rotary platform 16 rotationally mounted about an axis of rotation R on the base 14.

It should be noted that according to the invention, and as will be described in detail below, the connection device is notable in that it comprises a pivotable cover bearing blocking means that are specifically arranged on an elastically deformable tongue. Such a configuration can be implemented independently of the presence of a rotary platform pivotably mounted on the base. In the description which follows, details will be given about the structure of the rotary platform, without this being limiting for the invention.

In the example illustrated, the connection device 8 comprises three members, namely the connector 10, the base 14 and the rotary platform 16, articulated in pairs so as to allow, for the one part, the connector 10, and by extension the wiper 2, to be pivoted with respect to the connection module 12 and, for the other part, different types of wiper arm to be mounted on the connection module 12.

As can be seen more particularly in FIG. 3, the axis of pivoting P and the axis of rotation R may extend parallel to and separately from one another. In the example illustrated, the axis of pivoting P is formed substantially at the center of the base 14, relative to the longitudinal dimension of this base, and the axis of rotation R is formed at one of the longitudinal ends of the base 14. The longitudinal offset of the axis of rotation with respect to the axis of pivoting P and the axis of rotation R allows the rotary platform to be tilted into a mounting position which is inclined with respect to the longitudinal and transverse plane of the base, the tilting of this rotary platform allowing certain types of wiper arm to be mounted on this connection device 8.

The axis of pivoting P and the axis of rotation R may be offset vertically with respect to one another.

According to the invention and as can notably be seen in FIG. 2 and FIG. 3 and FIGS. 8 to 12, the connection device 8 comprises a cover 18 pivotably mounted about a pivot axis A, which in the example illustrated is parallel to the axis of pivoting P and to the axis of rotation R. The pivot axis A is in this case formed at a longitudinal end of the base 14 which is opposite the longitudinal end where the axis of rotation R is formed.

According to the invention, the cover 18 is configured to be movable between a covering position, fixing certain types of wiper arm to the connection device 8, and a release position, allowing certain types of wiper arm to be mounted on the connection device 8. The cover 18 thus participates in locking a position of the rotary platform 16 by cooperating with the free end 44 thereof. The cover 18 is notably in this position when an arm is secured to the connection module 12. It will thus be understood that the cooperation between components of the connection module, in this case the base and the rotary platform, and the cover 18 participates in securing the connection module 12 to the arm when the cover 18 is in the covering position. Conversely, when the cover 18 is in the release position, it no longer cooperates with said components of the connection module, thus allowing a possible uncoupling between the arm and the connection module 12, in order to be able to remove the connection module 12 from the arm, for example.

Furthermore, the connection device 8 may comprise, as can be seen in FIG. 2, a removable adapter 20 configured to be fastened to the rotary platform 16 and to enable the cooperation between the connection device 8 and certain types of wiper arm which cannot be fastened directly to the rotary platform.

To this end, this removable adapter 20 comprises means for fastening by snap-fitting that are able to cooperate with the rotary platform, and it further comprises means for fastening certain types of wiper arm.

In this example, as can be seen more particularly in FIG. 2, the connection device 8 may comprise a covering member 22 which is secured to the rotary platform 16 and/or to the base 14 and at least partially covers the connector 10, the rotary platform 16 and/or the base 14. The covering member 22 permits the cooperation between the connection device 8 and certain types of wiper arm.

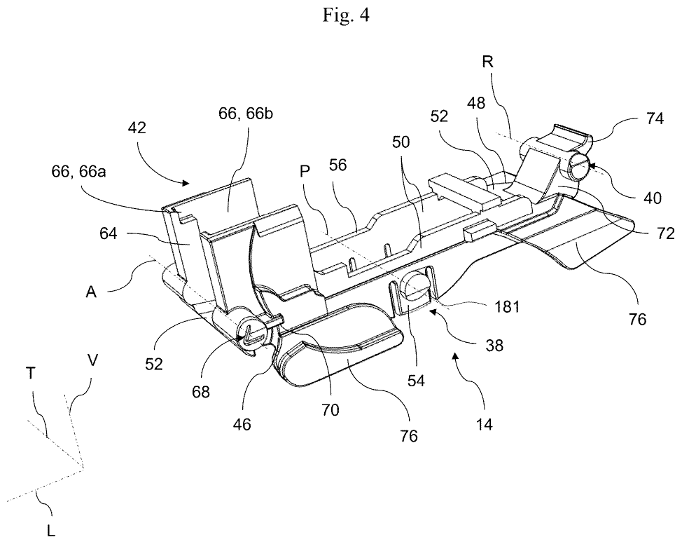

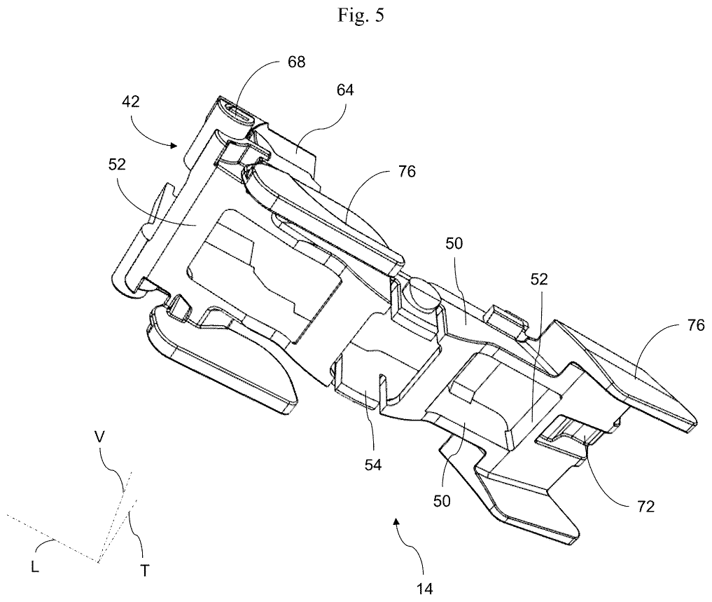

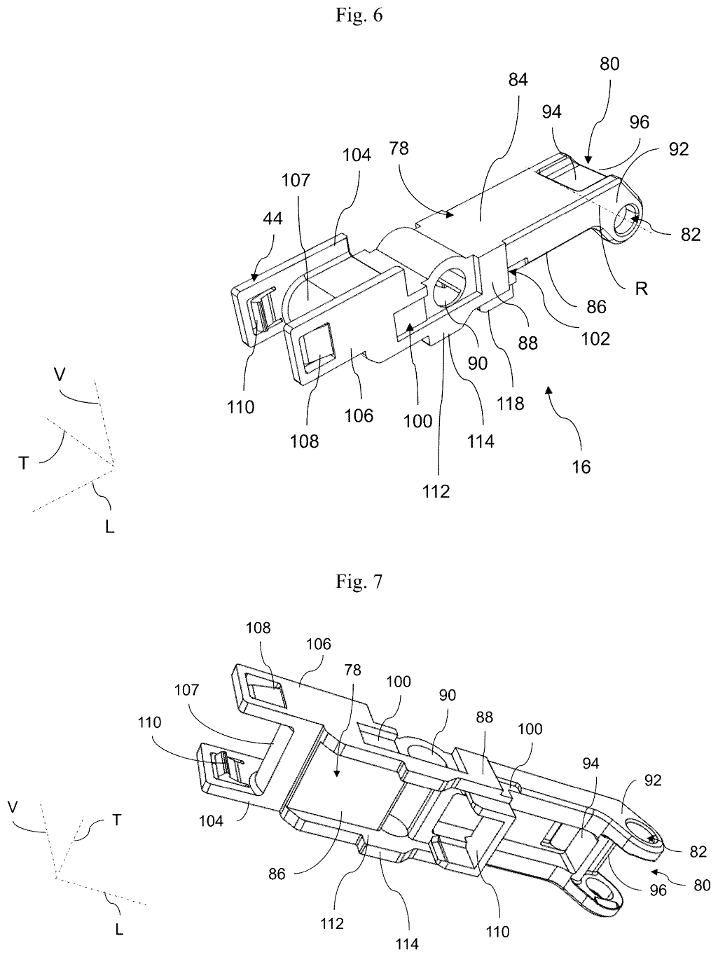

The connection module 12 will now be described in detail, in the illustrated example of a connection module comprising a base and a rotary platform, by in particular describing the base 14 with reference to FIG. 2, FIG. 3, FIG. 4 and FIG. 5 and the rotary platform 16 with reference to FIG. 2, FIG. 3, FIG. 4, FIG. 6 and FIG. 7.

The base 14 comprises a rotation member 40 able to cooperate with the rotary platform 16, in order to allow the platform to rotate with respect to the base about the axis of rotation R, and a guide block 42 intended to receive a free end 44 of the rotary platform 16. The base 14 extends longitudinally, having a first longitudinal end 46 in the vicinity of which the guide block 42 is disposed, and a second longitudinal end 48 in the vicinity of which the rotation member 40 is disposed. The guide block 42 is intended to receive, in addition to the free end 44 of the rotary platform 16, a particular type of wiper arm and thus to participate in securing it to the connection module 12. The rotation member 40, for its part, allows the rotation of the rotary platform 16 between a first position in which the free end 44 of the rotary platform 16 is disposed in the guide block 42 and a second position in which the free end 44 of the rotary platform 16 is disposed at a distance from the guide block 42.

In other words, it can be defined that the rotary platform 16 is movable between an illustrated first working position in which the rotary platform 16 is received in the guide block 42 of the base 14 and a second mounting position in which the free end 44 of the rotary platform 16 is disposed at a distance from the guide block 42.

These two positions of the rotary platform may in particular be defined in a plane perpendicular to the axis of rotation R, that is to say a plane parallel to the longitudinal L and vertical V directions. When the rotary platform 16 is in the first working position, the main axis of elongation of said rotary platform 16 is parallel to the main axis of elongation of the base 14, in this case the longitudinal axis L. When the rotary platform 16 is in the second mounting position, the main axis of elongation of said rotary platform 16 and the main axis of elongation of the base 14 are intersecting.

It will be understood here that the rotary platform 16 is in the first working position when a wiper arm is mounted in the connection device 8, whereas it is in the second mounting position when it is necessary for a wiper arm to be mounted on or removed from the wiper and the associated connection device 8.

The base 14 comprises a frame comprising at least two longitudinal walls 50 extending in the longitudinal direction L between the first longitudinal end 46 and the second longitudinal end 48 parallel to one another, and two transverse walls 52 extending perpendicularly and between the longitudinal walls 50, a first transverse wall 52 being disposed at the first longitudinal end 46 of the structure and facing the guide block 42 while the second transverse wall 52 is disposed at the second longitudinal end 48 and bears the rotation member 40. In other words, the transverse walls 52 extend parallel to the transverse direction T, in such a way as to form with the longitudinal walls 50 the frame bearing at least the guide block 42 and the rotation member 40.

At least one longitudinal wall 50 bears the above-mentioned pivot member 38 which is configured to cooperate with the pivot element 36 of the connector 10. It will be understood that the peg of the pivot member 38 extends toward the outside of the longitudinal wall 50 bearing it, i.e. away from the other longitudinal wall, in order to cooperate with the orifice of the pivot element 36 borne by the corresponding segment 34 of the connector 10.

More precisely, the pivot member 38 comprises a tongue 54 delimited longitudinally by at least one vertical groove 181 formed in the longitudinal wall 50, the tongue 54 bearing the peg extending transversely toward the outside of the base 14. The tongue 54 extends mainly in the vertical direction V, such that a bending axis of the tongue 54 extends parallel to the longitudinal direction L. The bending of the tongue 54 enables the mounting of the base 14 on the connector 10, the tongue 54 being movable about the bending axis during the mounting of the base 14 on the connector 10 so as to return to its initial position once the peg extends at least partially into the orifice of the segment 34.

The longitudinal walls 50 are spaced apart from one another such that they extend between the segments 34 of the connector 10 when the base 14 is fastened to the connector by snap-fitting, the base 14 extending at least partially into the housing defined by the segments 34 of the connector 10 as outlined above.

In addition, the longitudinal walls 50 each have a notch 56 extending longitudinally at an upper edge of the longitudinal wall 50.

The guide block 42, disposed at the first longitudinal end 46 of the base, comprises two lateral segments 64 extending parallel to one another, each in the vertical continuation of one of the longitudinal walls 50, in the direction away from the connector 10. The lateral segments 64 notably participate in delimiting a housing for the free end 44 of the rotary platform 16 when the latter is in the first working position.

The guide block 42 comprises at least one cutout 66 formed on an inner face of one of the lateral segments 64. Preferably, each of the inner faces of the lateral segments 64 has a cutout 66. At least one cutout participates in forming a hollow for receiving the free end 44 of the rotary platform 16.

More particularly, in the example illustrated, the guide block 42 comprises, on at least one of the lateral segments, in this case both, a first cutout 66a cooperating with the cover 18 and a second cutout 66b cooperating with the rotary platform 16, each of the cutouts 66a, 66b being disposed on the inner face of the corresponding lateral segment 64. It will be understood here that the second cutout 66b is configured to cooperate with the free end 44 of the rotary platform 16 when the latter is in its working position, while the first cutout 66a is configured to cooperate with the cover 18 to block the latter in the covering position, thus fixing at least the position of the rotary platform 16, and advantageously the position of a wiper arm.

According to the example illustrated in particular in FIG. 4, the first cutout 66a and the second cutout 66b are in communication with one another such that they form just a single cutout 66 having two zones, one of which cooperates with the rotary platform 16 while the other cooperates with the cover 18, but it should be noted that the first cutout and the second cutout could be made separately from one another without departing from the context of the invention.

Furthermore, the base 14 comprises a pivot member 68 able to cooperate with a pivot element 182 of the cover 18 so as to form a pivot device between the base and the cover around the pivot axis A. The cover 18 is thus movable between the covering position in which the cover 18 is in contact with the guide block 42, at least partially covering the housing of the free end 44 of the rotary platform 16 and one end of a wiper arm fastened to the connection device, and the release position in which the cover 18 is at a distance from the guide block 42, in order in particular to allow the mounting of a wiper arm on the rotary platform in its mounting position. In this case, the pivot member 68 comprises at least one shaft protruding transversely from the base 14 in the vicinity of the first longitudinal end 46 and cooperating with the pivot element 182 of the cover 18.

A stop means 70 is associated with the pivot member 68, for stopping the cover 18 as it pivots about the pivot axis A and blocking the cover 18 in its release position. The stop means 70 for example in this case takes the form of a pin extending from an outer face of one of the lateral segments 64 in the transverse direction T.

As illustrated, the lateral segments 64 may be symmetrical to one another with respect to a median plane of the base 14 perpendicular to the axis of pivoting P.

The rotary platform 16 will now be described in more detail notably with reference to FIG. 2, FIG. 3, FIG. 4, FIG. 6 and FIG. 7.

The rotary platform 16 comprises a body 78 extending in the longitudinal direction L between the free end 44 configured to cooperate with the guide block 42 and a longitudinal edge 80 on which a rotation element 82 for rotating the rotary platform 16 about the axis of rotation R is installed.

The body 78 generally takes the form of a wall extending mainly in a plane parallel to the longitudinal L and transverse T directions. The body 78 has an upper surface 84, intended to be facing the wiper arm intended to be fastened to the connection device, a lower surface 86 intended to be facing the base 14, and two lateral flanks 88.

The rotary platform 16 comprises a bore 90 intended to form a bearing for receiving a rod of a wiper arm, the bore extending transversely in the body 78 and being open on at least one of the lateral flanks 88. It will be understood here that the wiper arm is mounted transversely on the connection device 8, the arm being housed in the bore 90 forming a receiving bearing, and this participates in securing the connection device 8 to the wiper arm.

The above-mentioned rotation element 82 is notably configured to cooperate with the rotation member 40 of the base 14 so that it can cause the rotational movement of the rotary platform 16 between the first working position and the second mounting position as outlined above.

Furthermore, the rotary platform 16 is configured to cooperate with the removable adapter 20, so as to fasten the removable adapter 20 to the rotary platform 16. For example, the rotary platform 16 comprises a window 98 formed by the vertical offset between the guide wall 94 and the body 78 of the rotary platform 16, the window 98 being intended to receive a hook of the adapter 20.

In addition, the rotary platform 16 comprises at least one fastening zone 100 for fastening the removable adapter 20 to the body 78 of the rotary platform 16, the fastening zone 100 taking the form of a recess arranged on the lateral flank 88 of the body 78. Preferably, the rotary platform 16 comprises a pair of fastening zones 100 disposed on either side of a median plane of the rotary platform perpendicular to the axis of rotation R. These fastening zones are dimensioned to receive elastically deformable means on board the removable adapter.

In the example illustrated, the rotary platform 16 comprises two fastening zones 100 for fastening the adapter 20, which are arranged on the same lateral flank 88 of the body 78, in order to keep the removable adapter on the rotary platform.

As illustrated in FIG. 6 or FIG. 7, the free end 44 of the rotary platform 16 comprises a first flank 104 extending one of the lateral flanks 88 in the direction away from the rotation element 82 and a second flank 106 extending the other lateral flank 88 in the direction away from the rotation element 82 and parallel to the first flank 104, the first flank 104 and the second flank 106 defining a housing for receiving a type of wiper arm, notably a wiper arm having a hook.

To this end, at least one of the first and/or second flanks 104, 106 comprises an elastically deformable tongue 108 having a finger 110 extending into the housing for receiving the wiper arm, the elastically deformable tongue 108 being surrounded by a slit formed in the corresponding flank 104, 106. The initial shape of the tongue 108 and its elastically deformable nature make it possible to ensure, for the one part, that the wiper arm penetrates into the receiving housing between the flanks, and, for the other part, that each of the fingers 110 is in contact with the wiper arm when the latter is in place in the receiving housing.

In addition, the first and second flanks 104, 106 flank a receiving portion 107 of the rotary platform 16 intended to receive a portion of a hook of a type of arm, the receiving portion 107 having for example a curved profile.

Furthermore, at least one of the lateral flanks 88 comprises a bearing member 112 forming a protrusion on the edge between the lower surface 86 and this lateral flank, in such a way as to form a bearing edge 114 facing the base 14, this bearing edge 114 being intended to bear on the upper edge of the longitudinal wall 50 of the base 14, at the notch 56, when the rotary platform 16 is in the first working position.

As illustrated in FIG. 3, the specific shapes of the bearing member 112 and of the notch 56 participate in defining an opening 116 participating in blocking a particular type of wiper arm in position with respect to the connection module 12, this particular type of wiper arm comprising a fastening element able to be housed in the opening 116 which is closed when the rotary platform is folded down against the base and makes it possible to trap the fastening element of the wiper arm.

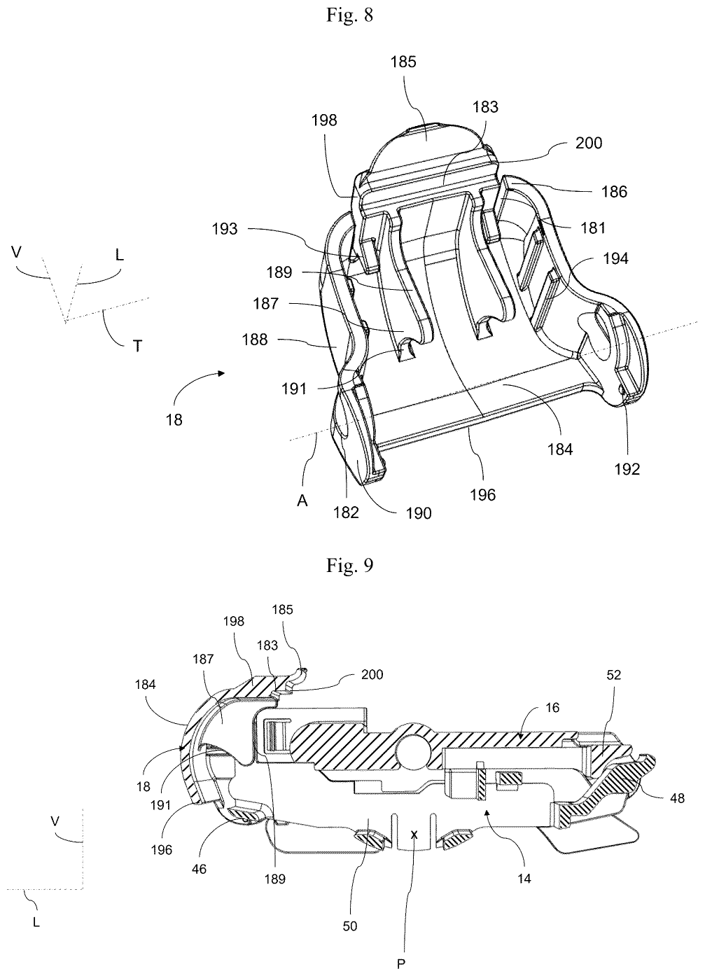

The cover 18 pivotably mounted on one of the components of the connection module, and more particularly in this case on the base 14, will now be described in more detail notably with reference to FIG. 2, FIG. 3, FIG. 8 and FIG. 9.

According to the invention, the cover 18 has an elastically deformable tongue 198 on which means for blocking at least one type of wiper arm are disposed, and on which means for blocking different types of wiper arm can be disposed.

As can be seen in FIG. 8, the cover 18 comprises at least a front wall 184, an upper wall 186 and two lateral walls 188, the front wall 184 and the upper wall 186 extending transversely between the lateral walls 188. More particularly, the front wall 184 extends generally in a plane parallel to the transverse T and vertical V directions, the upper wall 186 extending generally in a plane parallel to the longitudinal L and transverse T directions, the lateral walls 188 extending, for their part, in planes parallel to the longitudinal L and vertical V directions.

The lateral walls 188 at least partially bear the pivot element 182 at an end opposite the upper wall 186. It can be defined that the lateral walls 188 each have an upper end in contact with the upper wall 186 and a lower end vertically opposite the upper ends, the pivot element 182 thus being at least partially disposed at the lower ends of the pivot element 182.

More particularly, each of the lateral walls 188 comprises an extension portion 190 extending at their lower ends, the pivot element 182 being at least partially disposed on one and/or the other of the extension portions 190 of the lateral walls 188.

As can be seen in FIG. 8, the extension portions 190 are offset laterally with respect to the main planes of extension of the lateral walls 188. In other words, a main plane of extension of each of the extension portions 190 is separate from a plane in which one or the other of the lateral walls 188 extends.

In addition, the extension portions 190 have a greater spacing dimension than a spacing dimension measured between the lateral walls 188, these spacing dimensions being measured in this case in a direction parallel to the pivoting direction A and respectively between the inner faces of the extension portions 190 and the inner faces of the lateral walls 188. This difference between the spacing dimensions optimizes the mounting of the cover 18 on the base 14 while facilitating the pivoting of the cover 18 on the base 14.

The pivot element 182, for its part, comprises at least one orifice passing through one of the extension portions 190 of the lateral walls 188. It will be understood that the shaft of the pivot member 68 of the base 14 has an end which is at least partially housed in the orifice of the pivot member 182, thus forming the pivot device allowing the cover 18 to be pivoted about the pivoting direction A.

Preferably, each of the extension portions 190 bears a pivot element 182 which are aligned with respect to one another in a direction parallel to the pivot axis A. The base 14 advantageously bears two pivot members 68, each of these pivot members 68 cooperating with one of the two pivot elements 182 to form the pivot device, allowing the cover 18 to be movable between the covering position and the release position.

According to one feature of the invention, the pivot element 182 comprises at least one boss 192 protruding from an inner face of one of the lateral walls 188. The term “boss 192” is understood to mean a protuberance of relatively smaller size compared with a width of the lateral wall 188 from which it protrudes. The boss 192 for example in this case takes a substantially spherical shape. However, a boss 192 taking another shape would not depart from the scope of the invention.

The boss 192 is in this case intended to closely guide the cover 18 against a wall of the base 14 when the cover 18 is pivoted about the pivot axis A. More particularly, this close guidance is effected against an outer face of one of the longitudinal walls 50 of the base 14 and/or against an outer face of one of the lateral segments 64 of the guide block 42.

As can be seen in FIG. 8, the cover 18 comprises at least one rib 194 which extends along an inner face of a lateral wall 188 and is configured to bear against a wall of the guide block of the base. More precisely, the rib 194 extends from the front wall 184 toward a free end of the lateral wall 188 parallel to the longitudinal direction. In addition, the rib 194 forms a transverse protrusion from the lateral wall 188 of the cover toward the other lateral wall 188 of the cover.

The lateral wall 188 advantageously comprises two ribs 194 disposed one above the other in the vertical direction V, the two ribs 194 extending parallel to one another.

Preferably, the cover comprises at least one first rib 194 disposed on one of the lateral walls 188 and at least one second rib 194 disposed on the other lateral wall 188, the ribs 194 protruding toward the inside of the cover. The first rib 194 and the second rib 194 are aligned with respect to one another in a direction parallel to the pivot axis A. In addition, the first rib 194 extends parallel to the second rib 194.

The ribs 194 described above make it possible in this case to closely guide the lateral walls 188 against the lateral segments 64 of the guide block 42 or against the longitudinal walls of the base 14, in particular when the cover 18 is in the covering position.

The front wall 184, for its part, is formed in the continuation of the upper wall 186 and has a stop edge 196, on the opposite side from the upper wall 186, which is delimited transversely by the lateral walls 188. This stop edge 196 is in this case configured to cooperate with the base 14 in order to define the release position of the cover 18. In other words, the stop edge 196 is in contact with the base 14 when the cover 18 is in the release position.

More precisely, when the cover 18 is in the release position, the stop edge 196 is in contact with the guide block 42 of the base 14 and/or with the transverse wall 52 extending at the first longitudinal end 46 of the base 14.

Preferably, the stop edge 196 of the front wall 184 extends between the two extension portions 190 of the lateral walls 188. The stop edge 196 is in this case linear and extends parallel to the pivot axis A and is delimited transversely by the extension portions 190 of the lateral walls 188.

According to the invention, the cover 18 comprises an elastically deformable tongue 198 on which means for blocking at least one wiper arm are disposed.

In the example illustrated, the tongue extends on the upper wall 186 toward a free end of the upper wall 186. The term “elastically deformable” is understood to mean that the tongue returns to its initial position after having been subjected to deformation following a force exerted on said tongue.

As can be seen more particularly in FIG. 8, the elastically deformable tongue 198 extends mainly toward the base 14 and/or the rotary platform 16. More precisely, the elastically deformable tongue 198 extends longitudinally from the front wall 184 toward the base 14 and/or the rotary platform 16 and has a free end edge 200.

The elastically deformable tongue 198 advantageously has a thickness greater than the average thickness of the upper wall 186, the thickness being measured in this case in a direction perpendicular to the main plane of extension of the upper wall 186 and/or of the elastically deformable tongue 198. This extra thickness leads to a stiffening of the elastically deformable tongue 198 so as to optimize the solidity of said tongue.

The tongue is movable about a bending direction parallel to the pivoting direction A. More particularly, in this case, the elastically deformable tongue 198 is delimited by two longitudinal grooves 181 opening out onto the free end edge 200 of the upper wall 186, and the arrangement of these longitudinal grooves gives the elastically deformable tongue 198 mobility about a bending direction parallel to the pivoting direction A. Preferably, the two grooves 181 extend parallel to one another and have the same dimensions, both transverse and longitudinal, from the free end edge of the top wall.

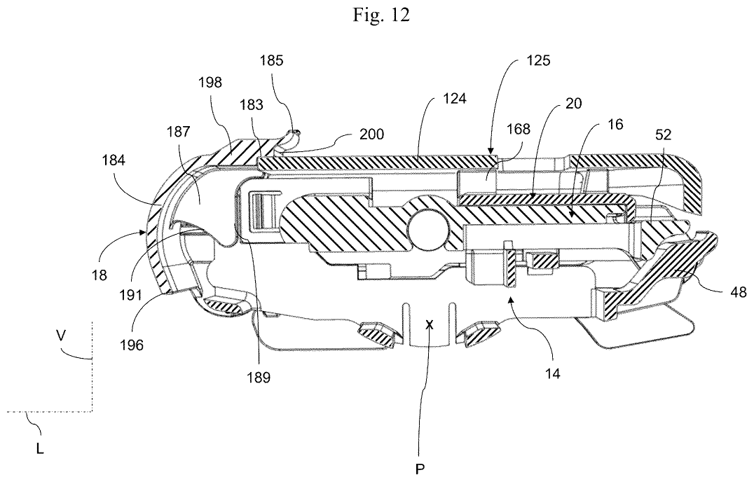

The free end edge 200 of the elastically deformable tongue 198 has a shoulder 183 intended to cooperate with a type of wiper arm. As will be more particularly described below with reference to FIG. 12, the shoulder 183 forms one of the blocking means disposed on the elastically deformable tongue in that it is configured to cooperate with a yoke of an arm, for example so as to longitudinally and vertically block the position of the connection device 8 on the arm.

The elastically deformable tongue 198 has a gripping tab 185 extending in the continuation of the free end edge 200. This gripping tab 185 makes it possible for a user to be able to more easily move the cover from the covering position to the release position. The gripping tab 185 takes a curved shape seen in a plane perpendicular to the pivot axis A. Moreover, and as will be described in more detail with reference to FIG. 11, the gripping tab 185 may form one of the blocking means disposed on the elastically deformable tongue, this gripping tab being configured to cooperate with a yoke of an arm, for example so as to longitudinally and vertically block the position of the connection device 8 on the arm.

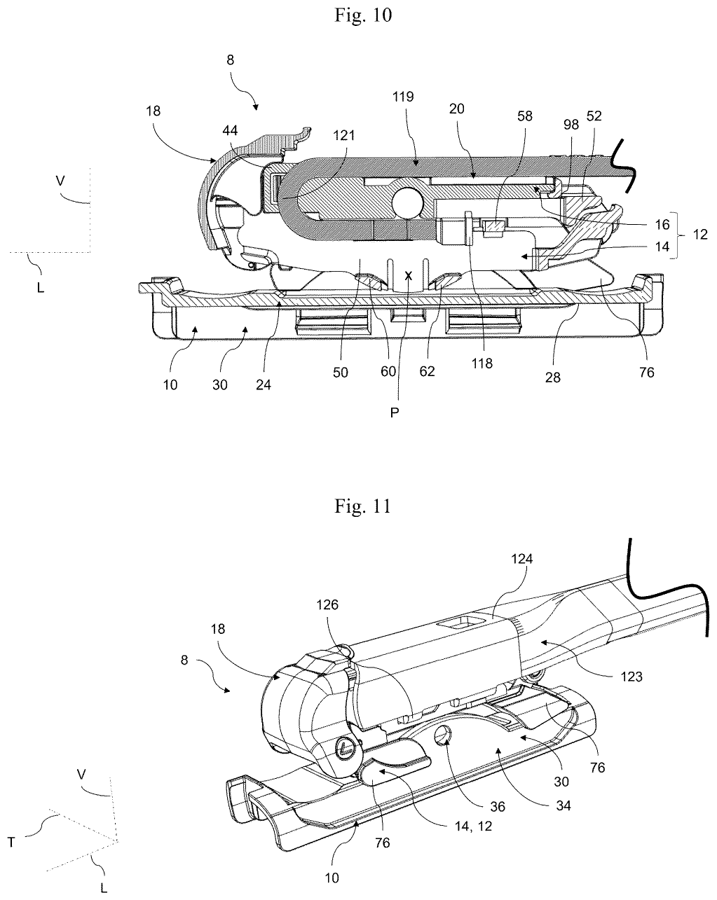

The cover according to the invention may comprise other blocking means, including, as can be seen in particular in FIG. 8, a wedging means 187, taking the form of a fin, extending in a plane perpendicular to the pivoting direction from the front wall 184 toward the connection module. The fin 187 forming the wedging means is secured to the front wall 184 and also to the elastically deformable tongue 198, such that it forms one of the blocking means disposed on the elastically deformable tongue within the meaning of the invention. As will notably be described with reference to FIG. 10, the wedging means 187 is thus configured to longitudinally block the position of a type of arm. In addition, the wedging means 187 stiffens the bending of the elastically deformable tongue 198, limiting the risk of irreversible deformation or breakage of said elastically deformable tongue 198.

In this case, the fin forming the wedging means 187 has a front edge 189 facing the base and/or the rotary platform, and a curved edge 191 facing the front wall, the front edge 189 participates, for example, in longitudinally blocking the position of a type of arm on which the connection device 8 is mounted.

Preferably, the cover comprises two fins 187 which are symmetrical to one another with respect to a median plane of the base 14 perpendicular to the pivot axis A.

The cover also comprises at least one locking means 196, in this case in the form of a locking tooth, which extends from the elastically deformable tongue 198, the locking tooth 193 being intended to cooperate with a cutout 66, 66a, 66b of the guide block 42 in order to block the cover in the covering position. More precisely, the locking tooth 193 cooperates with the first cutout 66a of the guide block 42.

Preferably, the cover comprises two locking teeth 193 which are symmetrical to one another with respect to a median plane of the base 14 perpendicular to the pivot axis A. Each of the locking teeth 193 cooperates with one of the first cutouts 66a of the guide block 42 in order to block the cover 18 in the covering position. In addition, the two locking teeth 193 transversely flank the two fins 187.

In this context, as can for example be seen in FIG. 8, the one or more locking means 193 and the blocking means of a wiper arm are all borne by the elastically deformable tongue. In order to be able to integrate these different means on this single tongue, the at least one locking means and the at least one wedging means are offset with respect to one another along the pivot axis A. And further blocking means are disposed at the free end edge of the tongue.

In a variant (not shown), the locking means 196 of the cover may take the form of a locking stud, disposed on at least one lateral face of the cover, configured to cooperate with a corresponding through-opening of the guide block 42 of the base in order to block the cover in the covering position.

Furthermore, the cover 18 may be particularly useful in the context described above in which the connector 10, the base 14 and the rotary platform 16 cooperate with one another such that the connection device 8 can assume a mounting position, during which the rotary platform 16 is in the second mounting position, and a working position, during which the rotary platform 16 is in the first working position. When it is in the covering position, the cover 18 makes it possible to form a stop for the free end 44 of the rotary platform 16, notably when the latter is in the first working position. The free end 44 then abuts, for example, against a lower face of the elastically deformable tongue 198, preventing the rotary platform from assuming the second mounting position.

By virtue of the specific shape of the cover and the integration of different blocking, wedging and locking means on an elastically deformable tongue of the cover, different types of wiper arm can be mounted on the connection device 8.

As illustrated in FIG. 10, one type of wiper arm 119 may comprise a hook 121, the latter extending at least partially into a receiving housing defined by the components of the connection module, in this case defined at least partially by the first and second flanks 104, 106 of the rotary platform 16. It will be understood here that, in order to mount the connection device 8 on the hook 121 of the arm 119, the cover 18 is positioned beforehand in the release position by pivoting about the pivot axis A, in order to enable the rotary platform 16 to be positioned in the second mounting position, if necessary, by rotation about the axis of rotation R, so as to release the free end 44 of the rotary platform and in particular the receiving portion 107 formed between the two flanks 104, 106. The end of the hook 121 is slid under the rotary platform 16, facing the lower surface 86 of the body 78, and the hook is brought back in the direction of the platform until the hook is in abutment against the receiving portion 107 and the end of the hook is in contact with the guide element 118. In this movement, the wiper arm first moves apart the elastic tongues 108 and the fingers 110 formed on the flanks 104, 106 of the free end of the rotary platform 16. The wiper arm having a hook 121 is held in position against the rotary platform by the elastic return into position of the fingers 110 which tends to press the hook against the receiving portion. The position of the arm with respect to the connection device is then secured and locked by folding the rotary platform down against the base and positioning the cover 18 in the covering position, blocking the position of the rotary platform by abutment of the free end 44 against the elastically deformable tongue 198 of the cover 18, and in particular against the wedging means 187. In this position, the wedging means 187 also participate in forming a longitudinal stop for the movement of the wiper arm having a hook 121 if the fingers 110 no longer fulfill their longitudinal retention function, for example, or if such fingers are not provided.

Alternatively, this type of wiper arm 119 having a hook 121 may be inserted into the connection device 8 in the manner described above once the rotary platform 16 is in the working position and the covering member 22 covers the connection module 12, as long as the cover 18 is in its release position.

Furthermore, the mounting and the cooperation of the wiper arm 119 having a hook 121 has in this case been described and illustrated without the covering member 22 mentioned above being present, but it should be noted that the connection according to the invention, and in particular the shape of the covering member, is designed to allow the hook 121 to be mounted on the connection module with the presence of the covering member.

As illustrated in FIG. 11, one type of wiper arm 123 comprises a yoke 124 at least partially covering the connection module 12, the arm 123 comprising at least one fastening element 126 which is trapped in the opening delimited by the bearing member 112 of the rotary platform 16 and the notch 56 of the base 14 when the rotary platform 16 is folded down against the base 14. It will be understood here that, in order to mount the connection device 8 on the type of wiper arm 123, the cover 18 is positioned beforehand in the release position by pivoting about the pivot axis A, in order to enable the rotary platform 16 to be positioned in the second mounting position, by rotation about the axis of rotation R, so as to be able to introduce the fastening element 126 into the opening without forcing this fastening element and weakening it. The rotary platform 16 is then folded down against the base 14, by rotation about the axis of rotation R, in order to close the opening and trap the fastening element. The cover 18 is then folded down into the covering position in order to block the position of the rotary platform 16. More particularly, in this cooperation with this type of wiper arm 123, it is the gripping tab 185 which forms one of the blocking means disposed on the elastically deformable tongue, by vertically covering the end edge of the yoke of this type of wiper arm 123.

Another type of wiper arm 125, also comprising a yoke 124 able to at least partially cover the connection module 12, is illustrated in FIG. 12. A free end of the yoke 124 is covered by the cover 18 in its covering position, in order to vertically block the yoke 124 with respect to the connection device 8, and the yoke 124 rests opposite/on the other side against at least one of the studs 168 of the removable adapter 20. One end of the yoke 124 is thus received in the shoulder 183 of the elastically deformable tongue 198 of the cover 18, which forms, as mentioned, one of the blocking means borne by the cover.

This type of wiper arm 125 may be mounted on the connection device with a rotary platform 16 which is both in its first working position and in its second mounting position, as long as the cover is pivoted to take up its release position. Once the wiper arm is in position on the connection module and in particular on the removable adapter 20, the cover can be folded down to trap the free end of the yoke 124.

These various examples of cooperation between a connection device and a wiper arm show the benefit of having the blocking means, and in this case the shoulder for example, on an elastically deformable tongue, because this makes it possible to absorb the assembly clearances and to ensure contact between the wiper arm to be blocked and the blocking means. Regardless of the number of components forming the connection module, and for example in the case of a platform that is rotatable with respect to the base with the possible movements of the various components within the connection module which increase the assembly clearances, it is advantageous to be able to rely on the flexibility of the elastically deformable tongue to adapt to the position of the wiper arm to be blocked and to ensure that the blocking means borne by the cover are in contact with or as close as possible to the wiper arm to be blocked.

However, the present invention is not limited to the means and configurations described and illustrated here and it also extends to any equivalent means and configuration and to any technically operational combination of such means.

What is claimed is:

1. A connection module for connecting a connection device of a wiper extending in a longitudinal direction to an arm of a wiper system, the connection module being, for the one part, able to be mounted on a connector of the connection device configured to bear the wiper and, for the other part, able to be connected to the arm, the connection module comprising a cover that is pivotable about a pivot axis and includes blocking means for blocking at least one type of arm, wherein the cover has an elastically deformable tongue on which the blocking means are disposed.

2. The connection module as claimed in claim 1, wherein the elastically deformable tongue is movable about a bending direction parallel to the pivot axis.

3. The connection module as claimed in claim 1, wherein the elastically deformable tongue is formed in an upper wall configured to at least partially cover the arm in a covering position of the cover.

4. The connection module as claimed in claim 3, wherein the elastically deformable tongue has a thickness greater than the average thickness of the upper wall.

5. The connection module as claimed in claim 3, wherein the elastically deformable tongue is delimited by two longitudinal grooves opening out at a free end edge of the upper wall.

6. The connection module as claimed in claim 3, wherein one of the blocking means includes a shoulder formed in a free end edge of an upper wall, the shoulder being intended to cooperate with a type of wiper arm.

7. The connection module as claimed in claim 5, wherein a gripping tab extends in the continuation of the free end edge of the elastically deformable tongue.

8. The connection module as claimed in claim 1, wherein one of the blocking means includes at least one wedging means extending in a plane perpendicular to the pivot axis at least partially from the elastically deformable tongue, the wedging means being intended to longitudinally wedge the position of a type of arm.

9. The connection module as claimed is in claim 1, wherein the cover is pivotably mounted on a base of the connection module and wherein the cover includes at least one locking means which extends from the elastically deformable tongue and which is configured to cooperate with a complementary locking member formed on the base.

10. The connection module as claimed in claim 1, wherein the at least one locking means and the at least one wedging means, which are at least partially borne by the elastically deformable tongue, are offset with respect to one another along the pivot axis.

11. The connection module as claimed in claim 10, wherein a base is pivotably mounted about an axis of pivoting on the connector and a rotary platform rotatably mounted about an axis of rotation on the base and wherein the cover and the rotary platform are disposed on the base such that the cover in the covering position is able to cover a free end of the rotary platform in order to lock the rotary platform against the base.
